(19) United States
(12) Patent Application Publication
(10) Pub. No.: US 2008/0072430 A1
(43) Pub. Date: Mar. 27, 2008

(54) Electronic palm-held hair trimmer

(76) Inventors: Michael Cafaro, El Paso, TX (US); Rocky C.W. Cheng, Fotan (HK)

Correspondence Address: O'KEEFE, EGAN & PETERMAN, L.L.P.;Building C, Suite 200, 1101 Capital of Texas Highway South, Austin, TX, 78746, US

(21) Appl. No.: 11/526,204

(22) Filed: Sep. 22, 2006

(51) Int. Cl. B26B 19/28

(52) U.S. Cl. 30/45; 30/526

(57) ABSTRACT

An electronic palm-held hair trimmer has an ergonomically curved head with a trimmer housing that fits within a use's palm and fingers during use. The ergonomically curved head allows the user's hand to hold the hair trimmer in a manner that is generally perpendicular to the plane of the hair trimming mechanism during use. A detachable strap can be attached to clips on either side of the head for attaching to a use's hand to better support the hair trimmer. An On/OFF power button on the head is reachable by an index finger or middle finger of a use's hand while holding the hair trimmer in the palm of a use's hand. A turbo button is located with the power button, and allows for variable speeds of the trimming blades when activated. Attachments are provided for varying the amount of hair and length to be cut. The trimmer may be operated with a power cord or may include a rechargeable battery that is used as a power supply.

### TECHNICAL FIELD OF THE INVENTION

This invention relates to an electronic hair trimmer, and more particularly to an ergonomically shaped, palm-held electronic hair trimmer.

### BACKGROUND

Certain electronic hair trimmers or clippers for trimming or clipping hair are known in the art, particularly for use in cutting hair from the head and neck areas. Some trimmers have moveable heads that pivot or swivel during use. Current hair trimmers typically have an elongated handle with a head attached at one end housing trimming blades. The elongated handle of the current art has a power switch, which can have variable speeds for causing the trimming blades to move at various speeds. The trimming blades are made up of one or more rows of stationary blades and one or more rows of blades parallel to the stationary blades that move in a side to side motion when a connected power switch is activated. A user holds the elongated handle while operating the hair trimmer of the current art, which can make certain use angles awkward, especially if a user is cutting his own hair. Current trimmers are also difficult to use with precision due to the current art elongated handle and difficulty applying pressure at certain angles. With current trimmers, a user typically does not hold the trimmer at the end having the trimming blades, but rather generally holds an elongated handle. Many current trimmers have attachments covering blades for regulating how close the blades come in contact with hair, as well as amount of hair that is cut. For example, a thinner attachment allows the blades to get closer to the user's head and cut hair closer to the user's scalp, but if the apertures are narrow, less hair is exposed to the blades at one time. An attachment with larger apertures will allow more hair to be exposed to blades and a thicker attachment or an attachment with apertures that are further from the blades will cut hair further from the use's scalp.

### SUMMARY OF THE INVENTION

As disclosed herein, an electronic palm-held hair trimmer has an ergonomically curved head with a trimmer housing that fits within a use's palm and fingers during use. The ergonomically curved head allows the use's hand to hold the hair trimmer in a manner that is generally perpendicular to the plane of the hair trimming mechanism during use. A detachable strap can be attached to clips on either side of the head for attaching to a use's hand to better support the hair trimmer. An On/OFF power button on the head is reachable by an index finger or middle finger of a use's hand while holding the hair trimmer in the palm of a use's hand. A turbo button is located with the power button, and allows for variable speeds of the trimming blades when activated. Attachments are provided for varying the amount of hair and length to be cut. The trimmer may be operated with a power cord or may include a rechargeable battery that is used as a power supply.

As described below, other features and variations can be implemented, if desired, and a related method can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1A is a side view of a palm-held electronic hair trimmer;

FIG. 1B is a top view of a palm-held electronic hair trimmer;

FIG. 1C is a bottom view of a palm-held electronic hair trimmer;

FIG. 1D is a front view of a palm-held electronic hair trimmer;

FIG. 1E is a rear view of a palm-held electronic hair trimmer;

FIG. 2A is a side view of a palm-held electronic hair trimmer with an attachment;

FIG. 2B is a top view of an attachment for a palm-held electronic hair trimmer;

FIG. 3 is a side view of a palm-held electronic hair trimmer held in a hand;

FIG. 4A is a side view of a palm-held electronic hair trimmer having a strap;

FIG. 4B is another side view of a palm-held electronic hair trimmer having a strap;

FIG. 4B is a side view of a palm-held electronic hair trimmer held in a hand supported by a strap;

FIG. 5 is a side view of a palm-held electronic hair trimmer held in a hand and secured via a strap;

FIG. 6A is a bottom view of a palm-held electronic hair trimmer showing a ninety degree angle rotation setting; and

FIG. 6B is a bottom view of a palm-held electronic hair trimmer showing a one hundred eighty degree angle rotation setting.

### DETAILED DESCRIPTION OF THE INVENTION

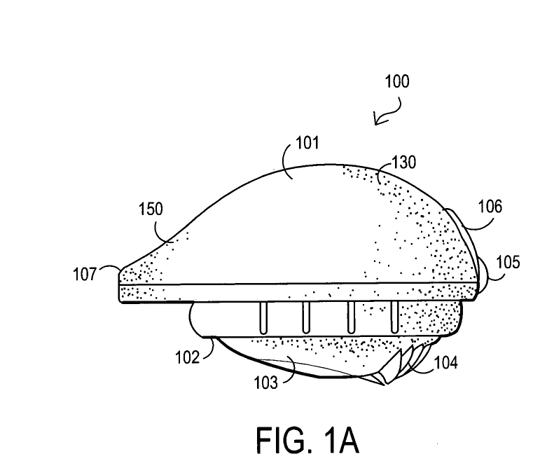

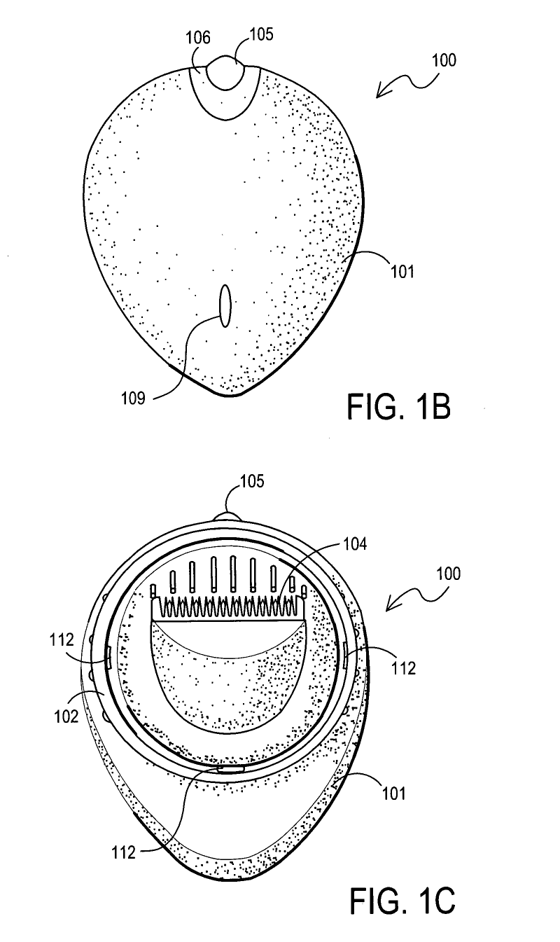

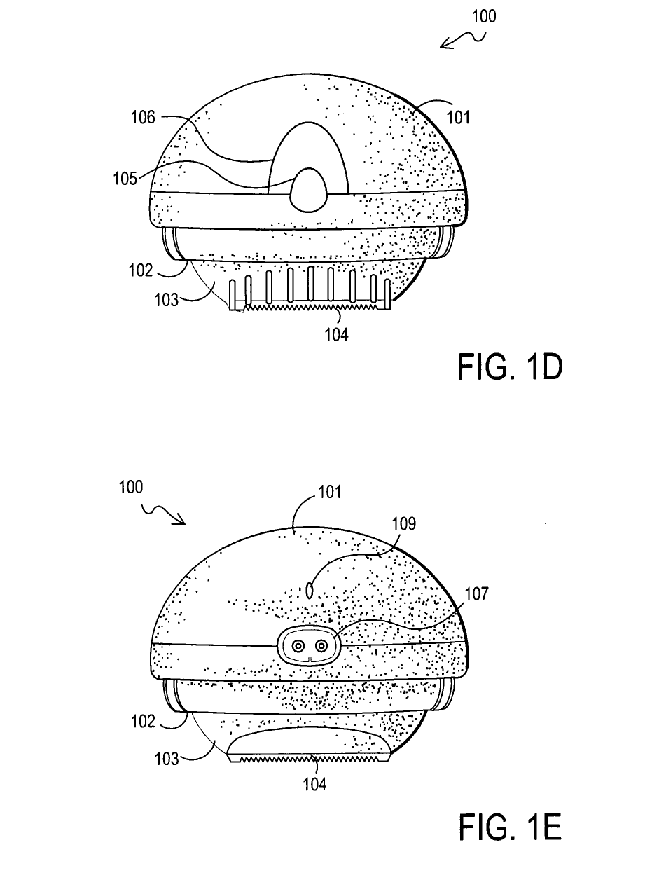

An electronic palm-held hair trimmer having an ergonomically curved head configured to be held in a use's palm during use. In an exemplary embodiment, a detachable strap can be attached to clips on either side of the head for assisting a user in holding the hair trimmer. FIGS. 1A-1E show various views of one embodiment of an electronic palm-held hair trimmer. FIG. 1A shows a side view of one embodiment of an electronic palm-held hair trimmer 100 having an ergonomically curved head 101 shaped to fit comfortably and securely in a use's palm. FIG. 1B illustrates a top view of the palm-held hair trimmer 100 and FIG. 1C illustrates a bottom view of the palm-held hair trimmer 100. FIGS. 1D and 1E illustrate front and rear views respectively of the palm-held hair trimmer 100.

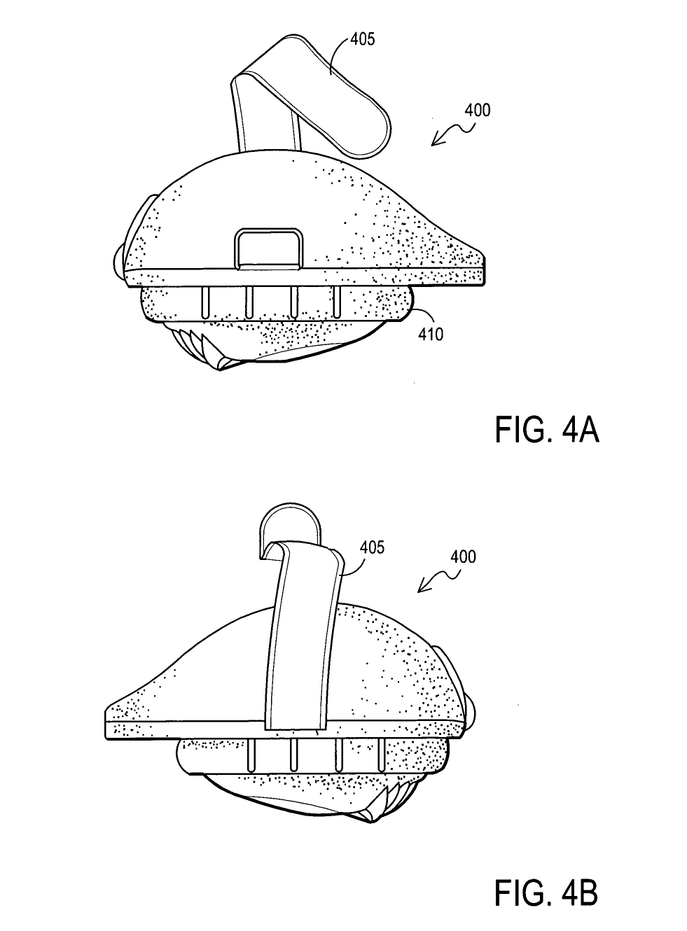

Holding a trimmer 100 in a palm allows a user more freedom of movement for trimming hair at various angles, as well as allowing a user to apply direct pressure with a hand instead of pressure leveraged with a handle. The head 101 can be available in various sizes, such as small, medium, large, extra large, or the like, to fit various hand sizes of users. For example, a small or medium sized head may fit women more comfortable than a large or extra large sized head, which may be more appropriate for most men. A face 102 is located opposite the back of the head 101. The head 101 may include a holding strip and clips or some other mechanism for assisting a user in holding the trimmer (discussed in more detail with reference to FIGS. 4A and 4B). Also on the head 101 is an ON/OFF power button 105 for activating an internal electronic system. A turbo button 106 is located with the power button 105, and regulates various speeds of the trimming blades 104, via the electronic system.

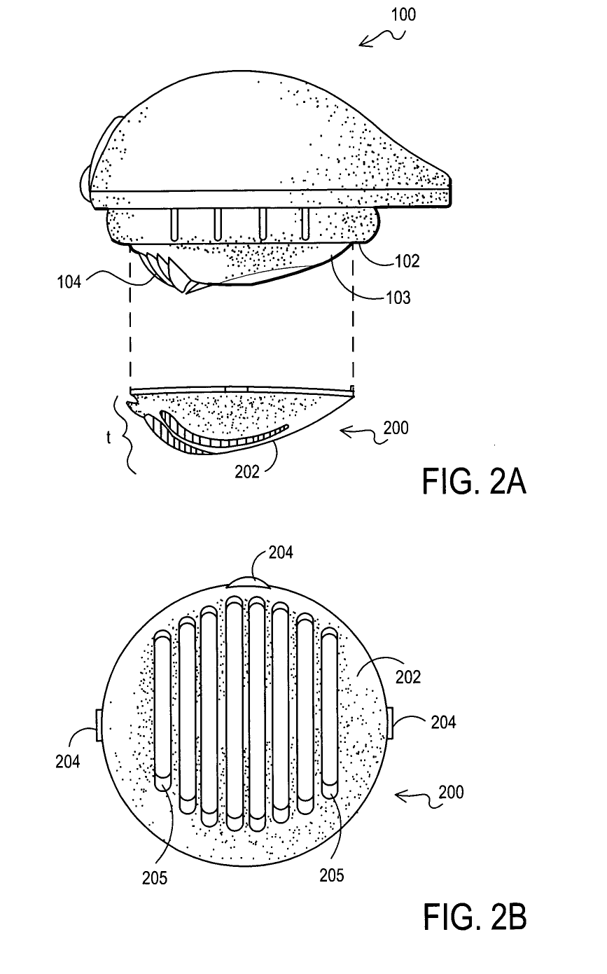

The face 102 has a trimmer housing 103 that holds trimming blades 104. The trimming blades 104 may be comprised of one or more rows of stationary blades, and one or more rows of blades that move in a side to side motion parallel to the stationary blades. The trimming blades 104 may be configured to be easily removable for cleaning or replacing. Attachments (described in more detail with reference to FIGS. 2A and 2B) are available for covering the trimming blades 104 to provide safety to a user, as well as regulate a desired amount and length of hair cut. The concepts described herein may be utilized independent of the shape, type and motion of the trimming blades. Generally it is merely desirable that the trimming mechanism be located under the face 102 of the head 101. Thus for example, though described with respect to side to side type moving blades, a wide range of other blade arrangements as known in the art may be utilized.

A charging connection 107 is located on the head 101 and is configured for plugging in an electrical cord. The trimmer 100 can be operated while the electrical cord is plugged into the charging connection 107 or after an internal rechargeable battery has been sufficiently charged via the charging connection 107. An LED light 109 indicates whether the trimmer 100 requires charging with a red light, or whether the trimmer 100 is sufficiently charged when a green light is displayed. The location of the charging connection 107 allows for use of the hair trimmer 100 even when connected to an electrical cord in a manner so as not to impede hair trimming.

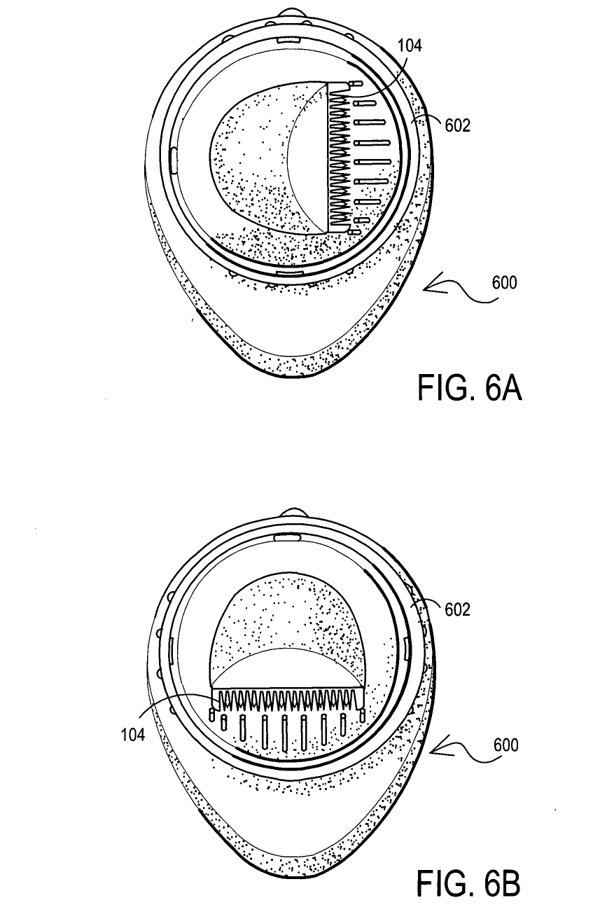

In one embodiment, trimmer housing 103 and trimming blades 104 may be in a stationary position with respect to the head 101. In an alternative embodiment (discussed in more detail with reference to FIGS. 6A and 6B), the trimmer housing 103 and trimming blades 104 may rotate with respect to the head 101

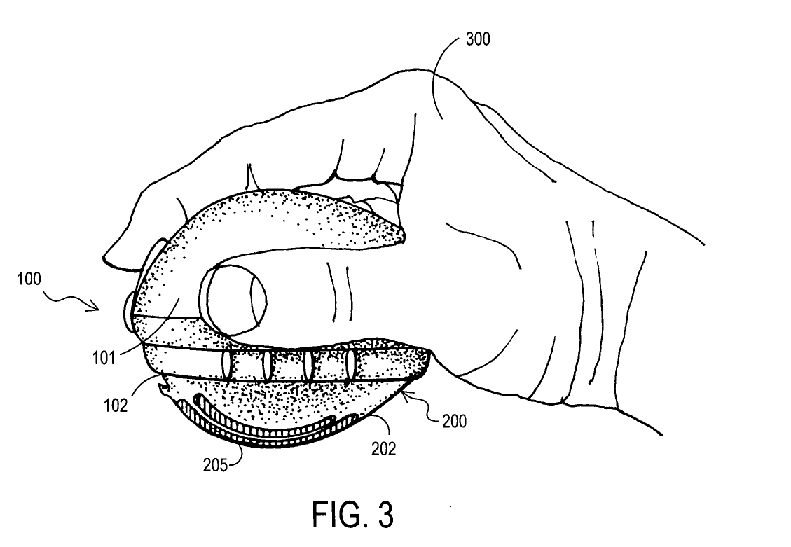

FIGS. 2A and 2B illustrate the use of an attachment for covering the trimming blades 104. As shown in FIG. 2A, an attachment 200 may engage the bottom of the hair trimmer 100 as indicated by the dashed lines. FIG. 2B illustrates the exposed face 202 of the attachment 200. Projections 204 are provided on the attachment 200. The projections 204 are configured to snap into place in slots 112 of the bottom face 102 of the hair trimmer (slots 112 being shown in FIG. 1C). In this manner, a user may removably attach and detach the attachment 200 from the hair trimmer 100. A hair trimmer 100 having an attachment 200 engaged to the hair trimmer 100 is shown in FIG. 3.

The attachment 200 improves safety by covering the trimming blades. The attachment 200 may also regulate the amount and length of hair trimmed. More particularly, different sized attachments may change the amount and length of hair trimmed. Thus though one attachment is shown, different attachments may be selectively snapped into place on the hair trimmer. Each attachment 200 may vary in thickness t resulting in varied distances of attachment face 202 from trimming blades and thus regulate the proximity of the trimming blades to a use's scalp. The attachment 200 can also vary in size of apertures 205 on attachment face 202. Larger apertures allow more hair to be exposed to trimming blades, while smaller apertures allow less hair to be exposed to trimming blades. A user would take into consideration the thickness and texture of hair being trimmed when deciding upon the type and size of attachment 200 to use in order to achieve the desired cutting effect. The attachments may be formed in a wide range of configurations and it will be recognized that the attachment shown is merely exemplary. For example, the attachment may be constructed to have a comb like shape on the attachment face.

FIG. 3 shows a side view of a palm-held electronic hair trimmer 100 as ergonomically held within a use's hand 300. As shown, the ergonomically curved head 101 fits within the palm and fingers of the use's hand 300 in a manner such that the face 102 of the trimmer 100 is opposite the fingers and palm. As shown in FIG. 3, the trimming blades are covered by an attachment 200 having a face 202 and apertures 205 as described above. An index finger or middle finger of a use's hand 300 may operate the power button and variable speed turbo button during use. A use's thumb can add stability to a use's operation of the trimmer by gripping the side of the hair trimmer head as shown. As can seen from FIG. 3, the ergonomically shaped curved head 101 of the hair trimmer 100 fits within the natural curvature of the hand 300. In this manner, the fingers and palm of the use's hand may easily grip the hair trimmer within the hand. Thus, the front to back of the hair trimmer substantially fits within the open palm and fingers of the user as opposed to a clenched fist type grip that surrounds a hair trimmer handle in prior art trimmers. Furthermore, the hand may engage the hair trimmer 100 on the side opposite of the trimming blades 104 (in FIG. 3 the hand engaging the top side of the hair trimmer and the trimming blades being located at the bottom side of the hair trimmer). Thus, direct downward pressure that is relatively perpendicular to the cutting face is applied through the palm and fingers of the user which move the hair trimmer into engagement with the hair. When engaged with the hair the motion of the hand is translated to being motion of the same general direction by the trimming mechanism. Thus, the trimming mechanism moves in the same general direction as a use's palm. Thus for example, a circular hand motion with create the relatively same circular motion by the trimming mechanism and the like. By holding the hair trimmer in the open palm and fingers directly opposite the trimming blades, improved range of motion and control is provided as opposed to traditional hair trimmers that are gripped by a handle and engaged with the hair through a motion that in which the cutting mechanism does not merely track the motion of a use's palm (for example because of the lever like effect of gripping an extended handle).

As described above, the head of the hair trimmer has an ergonomically curved head. As shown in FIGS. 1A and 3, the curvature of the head may be formed so as to be naturally “cupped” by the normal curvature of a relaxed palm and fingers. Thus, as can be seen by FIG. 1A, the head 101 includes a first region 130 that has a first radius of curvature for engaging a use's fingers and a second region 150 having a second different radius of curvature design to engage a use's palm. In one embodiment, the radius of curvature of region 130 may be concave while the radius of curvature of region 150 may be convex, however, such concave and convex configuration may not be necessary to still ergonomically fit within most use's hands. It will also be noticed with reference to FIGS. 1A, 1D and 1E that the curvature of the head includes curvature in a direction roughly parallel to a use's fingers (as seen in FIG. 1A) and curvature in a direction roughly perpendicular to a use's fingers (as seen in FIGS. 1D and 1E).

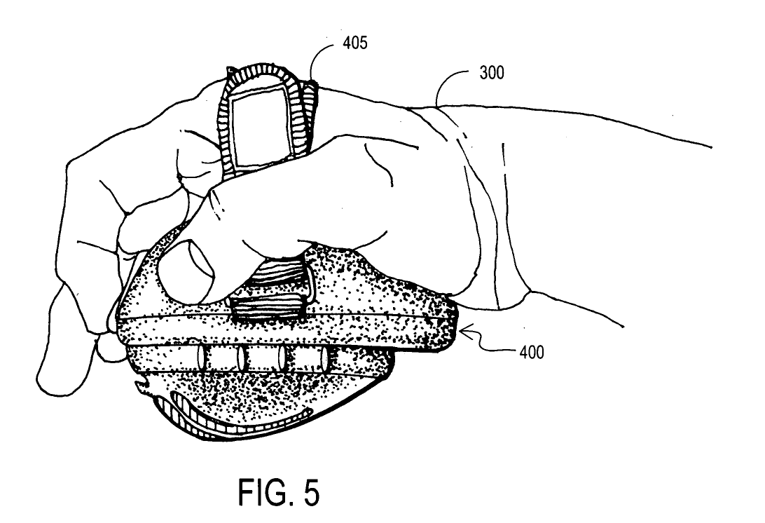

FIGS. 4A and 4B show a first and second side view of a palm-held electronic hair trimmer 400 that further includes a strap 405 for assisting a user in holding the hair trimmer. The strap 405 helps stabilizes the hair trimmer in a use's hand and can attach to clips or some other attachment mechanism to the sides of the hair trimmer head. The hair trimmer 400 may generally be configured similar to the hair trimmer of FIG. 1A except for the addition of the strap 405. The strap 405 may be utilized with a clip 410. In use the strap may be connected on one side of the hair trimmer 405 as shown in FIG. 4B and then threaded through the clip 410 on the other side of the hair trimmer 405. The strap may be tightened around a use's hand by the use of hook and loop type fasteners (such as for example Velcro) contained on the underside of the strap 405. It will be recognized that other structures may also be utilized to assist the holding of the hair trimmer by a user. For example the strap could be comprised of two connecting pieces that are attached on opposing sides of the hair trimmer head. Further, the attachment and tightening mechanism of such structures may be accomplished in a wide range of manners. FIG. 5 illustrates the use of the strap 405 of the hair trimmer 400 to assist the holding of the hair trimmer 400 within a use's hand 300.

As shown in FIG. 1C, the trimming blades 104 of the hair trimmer may be aligned with the front of the hair trimmer. Alternatively, the hair trimmer may be configured to allow the trimmer blades 104 to be rotated to different positions. Rotation of the trimmer blades 104 is illustrated in a bottom view of a hair trimmer 600 as shown in FIGS. 6A and 6B. In FIGS. 6A and 6B the hair trimmer 600 may be configured similar to the hair trimmer 100 of FIG. 1C except that the trimming blades 104 may be rotated. FIG. 6A illustrates a rotation of 90 degrees and FIG. 6B illustrates a rotation of 180 degrees. In one embodiment, the trimming blades may be rotated through rotate 360 degrees. Rotation may be accomplished by rotating the face 602 of the bottom of the hair trimmer 600 and the trimmer housing attached to the face. In another alternative, just the trimmer housing could be constructed to rotate. In one embodiment, the face 602 can have certain angles preset angles within the 360 degrees via preset settings for locking the face 602 into a certain angle for use. Rotation of the face 602 may cause the trimmer housing 103 and trimming blades 104 to rotate for cutting or trimming at different angles. By allowing rotation, the direction of cutting that a user may utilize with relation to the hair to be cut may be more easily extended as opposed to the range of directions that a user may achieve merely through movement of the hand or arm. This allows a user to cut their own hair at any angle without awkwardness or straining. In addition, the cutting angle may be changed while still retaining the same gripping location of the hand with respect to the head of the hair trimmer. In addition, rotation of the trimming blades allows a user to trim their own hair at various angles while maintaining the use's connection between the use's index finger and the power button and turbo button. Any of a wide range of techniques could be utilized to rotate the trimming blades and the palm held hair trimmer disclosed herein in not meant to be limited to any particular (if any) rotation mechanism.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. An electronic palm-held hair trimmer, comprising:
an ergonomically curved hair trimmer head sized to fit within and be held by a use's open palm and fingers; and
a face opposite the curved head having a hair trimming mechanism wherein motion of the trimming mechanism follows the same generally direction of motion of the open palm and fingers.

2. The hair trimmer of claim 1, further comprising a detachable strap configured for supporting a use's hand during use.

3. The hair trimmer of claim 2, wherein the strap attaches to a use's hand via hook and loop type fasteners.

4. The hair trimmer of claim 2, further comprising a power button reachable by a use's finger when the hair trimmer is held within the open palm and fingers.

5. The hair trimmer of claim 4, further comprising a turbo variable speed button reachable by the use's finger when the hair trimmer is held within the open palm and fingers.

6. The hair trimmer of claim 5, further comprising an attachment for covering the hair trimming mechanism.

7. The hair trimmer of claim 5, wherein the geometrical configuration of the attachment changes the hair trimming characteristics of the hair trimmer.

8. The hair trimmer of claim 5, wherein the attachment is detachable.

9. The hair trimmer of claim 1 further comprising at least one operation button reachable by a use's finger when the hair trimmer is held within the open palm and fingers.

10. The hair trimmer of claim 9, wherein the operation button is a power or speed button.

11. The hair trimmer of claim 10, further comprising a plug connection for an electrical cord.

12. The hair trimmer of claim 1, wherein the curved hair trimming head includes regions of differing amounts of curvature.

13. An electronic palm-held hair trimmer, comprising:
a first surface for holding the hair trimmer, the first surface having a curvature configured to ergonomically fit within the curvature of a use's relaxed fingers and palm; and
trimming blades on a side of the hair trimmer opposite the first surface.

14. The hair trimmer of claim 13, further comprising an attachment for covering the hair trimming mechanism.

15. The hair trimmer of claim 14, wherein the geometrical configuration of the attachment changes the hair trimming characteristics of the hair trimmer.

16. The hair trimmer of claim 14, wherein the attachment is detachable.

17. The hair trimmer of claim 13, further comprising at least one operation button reachable by a use's finger when the hair trimmer is held within the open palm and fingers.

18. The hair trimmer of claim 17, wherein the operation button is a power or speed button.

19. The hair trimmer of claim 13, further comprising a strap configured for supporting a use's hand during use.

20. The hair trimmer of claim 13, further comprising a charging connection.

21. The hair trimmer of claim 13, wherein the first surface includes regions of differing amounts of curvature.

22. The hair trimmer of claim 21, wherein the regions of differing amounts of curvature include a first region and a second region, the first region being configured to accept the curvature of the use's fingers and the second region configured to accept the curvature of the use's palm.

23. An electronic palm-held hair trimmer, comprising:
an ergonomically curved hair trimmer head having a curved surface configured to fit within the natural curvature of a use's relaxed hand; and
a side opposite the curved surface having a trimming mechanism disposed thereon, wherein motion directed relatively perpendicular to the open palm and fingers moves the hair trimming mechanism into a cutting position.

24. The hair trimmer of claim 23, further comprising a detachable attachment for covering at least a portion of the trimming mechanism so as to adjust the trimming characteristics of the hair trimmer.

25. The hair trimmer of claim 13, further comprising at least one operation button reachable by a use's finger when the hair trimmer is held within the open palm and fingers.

26. The hair trimmer of claim 21, wherein the curved surface includes a first region and a second region, the first region being configured to accept the curvature of the use's fingers and the second region configured to accept the curvature of the use's palm.

27. The hair trimmer of claim 21, wherein the curved surface includes curvature in a direction generally parallel with the use's fingers and curvature in a direction generally perpendicular to a use's fingers.
